(19) United States
(12) Patent Application Publication
(10) Pub. No.: US 2007/0225514 A1
(43) Pub. Date: Sep. 27, 2007

(54) Method for drying organic material employing a supercritical carbon dioxide process

(76) Inventors: Michael Wayne Davis, Rockford, MN (US); James Edward Bobier, Hutchinson, MN (US)

Correspondence Address: GEORGE BROWN, 317 SOUTH HARBOR DRIVE, VENICE, FL, 33595, US

(21) Appl. No.: 11/726,112

(22) Filed: Mar. 20, 2007

Related U.S. Application Data
(60) Provisional application No. 60/786,595, filed on Mar. 27, 2006.

(51) Int. Cl. C11B 1/00

(52) U.S. Cl. 554/9

(57) ABSTRACT

The removal of excess water from organic materials, specifically distillers grains, employing the use of supercritical carbon dioxide. The method includes the use of an extraction chamber, in which organic material containing excess moisture is subjected to a supercritical carbon dioxide loop which in turn solubilizes some of the water. Supercritical carbon dioxide enters the extraction chamber to offset the saturated, supercritical carbon dioxide which is removed from the extraction chamber. Upon exiting the chamber, the water is separated from the saturated supercritical carbon dioxide, after which the water depleted carbon dioxide is then returned to the extraction chamber again in the supercritical state; thus creating a carbon dioxide process loop.

### RELATED APPLICATIONS

This application claims priority to U.S. Provisional Application No. 60/786,595 filed Mar. 27, 2006 which is hereby incorporated by reference in its entirety.

### BACKGROUND OF INVENTION

1. Field of the Invention

The present invention relates to the use of supercritical carbon dioxide to remove excess water from grains. More preferably, this relates to the drying of distillers' grains produced in the production of ethanol.

2. Description of Related Art

The term “supercritical carbon dioxide” herein refers to a state in which carbon dioxide is neither in a gaseous or liquid state. Rather, it is a physical state which exhibits characteristics of both the gaseous and liquid states. Furthermore, the term “supercritical carbon dioxide” herein refers to carbon dioxide which is at a pressure of 73 atmospheres (roughly 1073 psi) or greater, and at a temperature of 31.1° C. or higher. Any potential condition of carbon dioxide with values equal to or greater than these two aforementioned variables is considered to be “supercritical”. The term “organic material” herein refers to material which is composed of and/or derived from plant or animal life, (flora & fauna). The term “distillers grains” herein refers to the remaining grain based, organic solids and solubles resulting from a fermentation and distillation process. More specifically, “distillers grains” refer to any of the typical grains used in alcohol production, such as but not limited to corn, wheat, and rice. The term “Wet Distillers Grains” (WDG) herein refers to any form of distillers grains and distillers grains with solubles with a water content greater than 20%. This includes wet distillers grains (WDG) and wet distillers grains with solubles (WDGS) which are typically 70% moisture, modified distillers grains (MDG) and modified distillers grains with solubles (MDGS) which are typically 50% moisture. The term “Dried Distillers Grains” (DDG) herein refers to any form of distillers grains and distillers grains with solubles with a water content less than 20%. This includes dried distillers grains (DDG) and dried distillers grains with solubles (DDGS).

Presently, a great amount of distillers grains are produced in the production of ethanol. The majority of these processing plants consume corn as the primary grain, and the resulting distillers grains are then used as livestock feed. Both wet distillers grains and dried distillers grains are commonly used as livestock feed. Wet distillers grains have some major disadvantages compared to dried distillers grains: lower food value to weight ratio resulting in greater shipping costs, shortened shelf life due to the high water content, difficulty in handling and transporting product since the outer surfaces of a pile will tend to naturally dry and crust over. The major disadvantage of dried distillers grains is the required amount of energy and associated cost consumed in the drying process. Distillers grains used for livestock feed are commonly dried to a range of 8 to 15% percent water content by weight. In doing so, the distillers grains become a granular product which can easily be handled, the food value to weight ratio increases so shipping costs are reduced, and the product can be stored for much longer periods of time. Currently, the common method used by ethanol plants for drying, or removing excess water, from distillers grains is by heating the wet distillers grains in a rotary tumble dryer. This is typically a singular or plurality of long rotary drums in which the wet distillers grains enter the drum from one end and are conveyed through the dryer while tumbled. The tumbling action is required in this application to prevent the distillers grains from caking together. These rotary driers are typically heated with natural gas, propane, or coal. An analysis of the current method for drying distillers grains as a co-product in the production of ethanol shows that a highly efficient system requires approximately 3000 BTUs of heat energy to remove 1 pound of water from the distillers grains. A method that consumes less energy would be highly desirable.

Supercritical carbon dioxide is used in many activities. These include, but are not limited to the decaffeination of coffee beans, removing oils from materials, and processing of semiconductor wafers. A method for drying water from semiconductor wafers using supercritical carbon dioxide and a co-solvent is provided in U.S. Pat. No. 6,398,875. Furthermore, a 3 step method for drying microstructure members employing supercritical carbon dioxide in one of the steps is provided in U.S. Pat. No. 6,804,900. A NASA abstract titled “Recovery of Minerals in Martian Soil via Supercritical Fluid Extraction” by Keneth Debelak of Vanderbilt University discloses how water is recovered from hydrated species of Martian soil when exposed to supercritical carbon dioxide. In this paper, it is disclosed that the solubility of water in supercritical carbon dioxide was experimentally found to be 0.052 mole fraction.

### SUMMARY OF THE INVENTION

Accordingly, the primary object of the present invention is to provide a method for drying organic materials such as but not limited to distillers grains in which water is removed from the distillers grains employing supercritical carbon dioxide or supercritical carbon dioxide and a co-solvent in a highly energy efficient and cost effective manner. In addition to this, a secondary object would be to simultaneously remove vegetable oil and water from the distillers grains, in which the oil could then be separated and captured as an additional co-product to the dried distillers grains. The addition of a co-solvent to aid in the removal of excess water for this application will be based upon the economics and quality of the finished products. The most likely candidate for use as a co-solvent is ethanol. The production of ethanol generates large amounts of readily available carbon dioxide and ethanol. The supercritical carbon dioxide system would most likely be a closed loop system in which the carbon dioxide is continually recovered and reused, but having the carbon dioxide supply on site minimizes the additional required equipment and acquisition costs of the carbon dioxide. If a relatively small amount of ethanol is employed as a co-solvent, it can easily be recaptured and distilled by re-introducing it into the main distillation system of the plant, minimizing amount of additional equipment required. With regard to compressing and heating the carbon dioxide gas to the supercritical stage, there are two primary methods available. The first method is to process the carbon dioxide in a liquid state, below the supercritical temperature and pressure. Then, using a liquid carbon dioxide pump, increase the pressure above the supercritical point. After the pressure is above the supercritical point, the liquid carbon dioxide is heated to increase the temperature above the supercritical point, thus converting the liquid carbon dioxide into supercritical carbon dioxide. This process may likely require chilling and heating of the carbon dioxide, which could potentially be accomplished with the use a heat exchanger system. A second method would be to process the carbon dioxide in a gaseous state, below the supercritical pressure and near or above the required supercritical temperature. Then, using a carbon dioxide gas compressor, increase the pressure above the supercritical point. In the process of compressing the gas, the temperature is already above the supercritical point, or the heat generated by the process of compressing the gas increases the temperature to the required supercritical point. In this method the carbon dioxide achieves a supercritical state while still in the compressor. The optimum condition will be determined by safety and long term economics. Some considerations will be, but are not limited to, cost of the equipment, reliability, safety, cost of processing, value of products; all which factor into maximizing the value of the co-products while minimizing the processing costs and risk. In addition to this, the economics and practicality of the power sources will be investigated as well for the carbon dioxide pump. It may be more desirable to use some other power source than electricity for compressing the carbon dioxide, such as but not limited to steam. A further goal of processing the distillers grains with a supercritical carbon dioxide process is to reduce or eliminate the need for agitation during drying. The current rotary drum dryers are required to prevent the distillers grains from sticking together while drying, this is especially true when the solubles are reintroduced to the dryer to be incorporated together. The use of a supercritical carbon dioxide system has the potential to greatly reduce or eliminate the tendency of this sticking effect. When saturated with supercritical carbon dioxide, all surface tension effects should be removed. The potential exists to remove the excess water from the distillers grains without agitation in the absence of surface tension between the grains. One of the potential desirable aspects of the current heat and tumble dry method is that the distillers grains are slightly toasted, which are valued by some purchasers of the dried distillers grains. For cases in which toasting is desired, once the distillers grains have been dried simply toast the distillers grains with the current state of the art tumbler method. Toasting of the grains will require far less energy than driving off the large amounts of water.

An optimal method would be the use of supercritical carbon dioxide to dry organic material under the conditions that result in the lowest operational cost. The specific operating pressure and temperature would be optimized so that the process operates at the lowest cost possible. Varying the process pressure and temperature of the supercritical carbon dioxide will impact the solubility rate for the amount of water that can be solubilized into a given amount of supercritical carbon dioxide. Under the optimal method, the pressure, temperature, and flow rate of the supercritical carbon dioxide would be carefully chosen so that the process operates at peak cost efficiency. Furthermore, the use of a viable co-solvent and the amount used, if any, is based solely on the optimization of the cost efficiency of the drying process. In addition, the optimal method will most likely fluctuate slightly with changes to market conditions and utility costs. Should ethanol be used as a co-solvent, changes to the market cost of ethanol may shift the optimized cost efficiency process to different operating conditions. This would also be true of the operating pressure, temperature, and flow rate of the supercritical carbon dioxide for which periodic changes may be justified due to shifts in energy costs.

The preferred method is a process in which the pressure of the supercritical carbon dioxide is between 1073 psi to 1500 psi and the temperature of the supercritical carbon dioxide in the extraction vessel is between 90° C. to 150° C. The solubility of water into supercritical carbon dioxide is fairly insensitive to pressure, so the lower pressure range is preferable from an equipment cost to benefit comparison. The solubility of water into supercritical carbon dioxide is sensitive to temperature, with the solubility increasing substantially near 100° C. and above. By using an extraction temperature of at least 90° C., the solubility ratio will be sufficient. By limiting the extraction temperature to 150° C. or below, heat damage to the organic material should be kept to acceptable levels. For organic materials in which there are no concerns of heat damage, the temperature could exceed 150° C.

### BRIEF DESCRIPTION OF THE DRAWINGS

FIG. 1 of the drawings is a schematic representation of a supercritical carbon dioxide extraction system in which water is extracted and recovered.

### DETAILED DESCRIPTION OF THE DRAWINGS

The embodiments of the present invention described below are not intended to be exhaustive or to limit the invention to the particular embodiments disclosed in the following detailed description. Rather, the embodiments are described so that others skilled in the art can understand the principles and practices of the present invention.

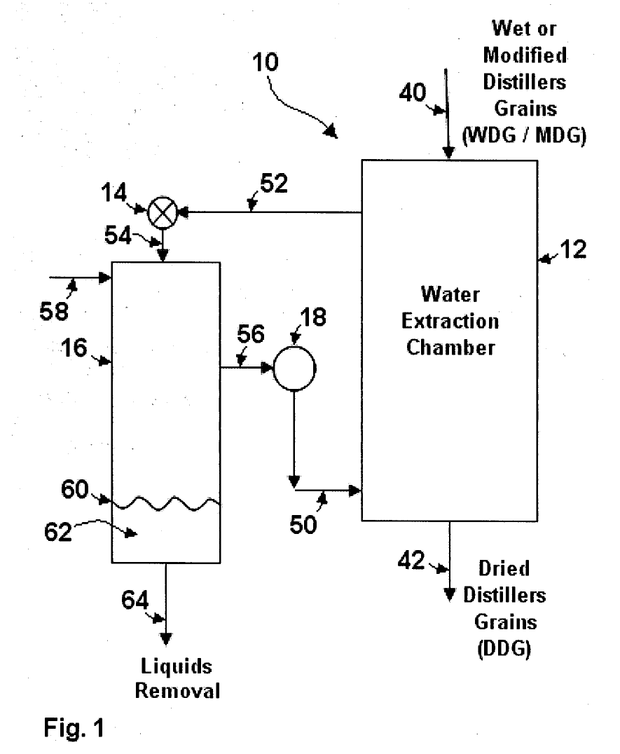

FIG. 1 of the drawings show a potential supercritical extraction process 10 for the removal of water from Wet Distillers Grains (WDG) or Modified Distillers Grains (MDG) 40. WDG or MDG 40 enters the water extraction chamber 12 while Dried Distillers Grains (DDG) exits the water extraction chamber 42. Supercritical carbon dioxide 50 is supplied to the water extraction chamber 12 by means of high pressure pump 18. The supercritical carbon dioxide solubilizes the water from the distillers grains in the water extraction chamber 12. Supercritical carbon dioxide which is loaded with solubilized water 52 exits the water extraction chamber 12 and passes across a pressure gate or orifice 14. Upon passing the pressure gate 14, the pressure is no longer high enough to sustain the supercritical state of the carbon dioxide. Gaseous carbon dioxide and water condensate and or vapor 54 exit the pressure gate 14 and enter the liquid recovery chamber 16. With the carbon dioxide in the gaseous state, the water easily separates out and collects at the bottom of the tank as liquid water 62. The liquid level 60 is the interface in the liquid recovery chamber 16 between the gaseous carbon dioxide and the liquid water 62. Liquid water 62 is removed from the chamber by means of an exit port 64 as needed. Gaseous carbon dioxide is supplied to the entire system by means of a gaseous carbon dioxide make-up supply 58 to offset the losses of carbon dioxide that occur as the distillers grains enter 40 and exit 42 the water extraction chamber 12 by means such as load locks. Gaseous carbon dioxide 56 exits the liquid recovery chamber 16 and proceeds to the high pressure pump 18, which upon exit from the high pressure pump 18 is supercritical carbon dioxide 50 due to the high pressure. This completes the entire process loop which runs continuously. In the description of FIG. 1, only water was extracted from the distillers grains. Other materials may also be extracted concurrently which were not described specifically.

It is recognized that changes, variations, and modifications may be made to this invention, particularly by those skilled in the art, without departing from the spirit and scope of this invention. Accordingly, no limitation is intended to be imposed on this invention, except as set forth in the accompanying claims.

We claim:

1. A method for removing excess water from organic materials consisting of the use of supercritical carbon dioxide.

2. A method as recited in claim 1 in which the organic material is distillers grains.

3. The method as recited in claim 2 in which the carbon dioxide is supplied to the system from the fermentation of the grain stock into ethanol.

4. The method as recited in claim 2 in which a co-solvent is used to aid in the removal of excess water.

5. The method as recited in claim 4 in which the co-solvent is ethanol.

6. The method as recited in claim 1 in which the removed excess water is recovered and recycled in the ethanol process.

7. The method as recited in claim 1 in which the organic material is biomass residuals from ethanol and/or cellulosic ethanol conversion processes.

8. The method as recited in claim 1 in which a co-solvent is used to aid in the removal of excess water.

9. The method as recited in claim 8 in which the co-solvent is ethanol.

10. A method for simultaneously removing grain oil and excess water from distillers grains consisting of the use of supercritical carbon dioxide.

11. The method as recited in claim 10 in which a co-solvent is used in addition to the supercritical carbon dioxide.

12. The method as recited in claim 11 in which the co-solvent is ethanol.
